(19) United States
(12) Patent Application Publication
(10) Pub. No.: US 2006/0230729 A1
(43) Pub. Date: Oct. 19, 2006

(54) Method and apparatus for capturing/collecting airborne hazardous particles generated by a moving vehicle

(76) Inventors: Hossein E. Tabrizi, (US); Alex Tabrizi, (US)

Correspondence Address: HOSSEIN E. TABRIZI, 835 AMIGOS WAY #1, NEWPORT BEACH, CA, 92660, US

(21) Appl. No.: 11/455,385

(22) Filed: Jun. 19, 2006

Related U.S. Application Data
(63) Continuation-in-part of application No. 11/384,716, filed on Dec. 28, 2004.

(51) Int. Cl. B01D 50/00

(52) U.S. Cl. 55/385.3

(57) ABSTRACT

A method and apparatus for capturing/collecting hazardous fumes and toxic particles generated by a set of rotating wheels on a moving vehicle is disclosed. This system uses a vacuum source to capture hazardous particles via directional air ducts which are located right above each tire. All air ducts are connected to the dust chamber via a main duct hose. In dust chamber, all receiving hazardous particles are contained and filtered.

### CROSS REFERENCE

This application is a continuation in part of U.S. patent application Ser. No. 11/384,716, filed on Dec. 28, 2004, entitled “Absorber of polluted air caused by brake pads” by Hossein E. Tabrizi and Alex Tabrizi.

### FIELD OF THE INVENTION

The present invention relates to collection of airborne hazardous particles generated by a set of rotating wheels of a moving vehicle and more specifically capturing hazardous particles are collection and contained in a vehicle's dust chamber.

### BACKGROUND OF THE INVENTION

It is well known in the art that a moving vehicle can generate exhaust air pollution by unburned gases at the tail pipe which causes air pollution. A moving vehicle can also generate hazardous fumes and toxic particles that are not related to unburned gases which are known as dust particles. These dust particles are generated by rotating wheels that consist of tire wear out particles, brake pads dust, asphalt dust, etc. These particles can be saturated in the air, especially in very populated cities with polluted air. This condition may cause health risk for human and/or any type of breathing mammals. This invention has attempted to reduce and to contain hazardous dust form particles generated by a vehicle and to provide better environment for future society.

### SUMMARY OF THE INVENTION

It is an object of the present invention to provide an apparatus to capture/collect hazardous fumes and toxic particles generated by a set of rotating wheels on a moving vehicle. The hazardous particles consist of tire wear out particles, brake pads dust, asphalt dust, etc. This system uses vacuum source to capture hazardous particles via directional air ducts which are located right above each tire. All air ducts are connected to the dust chamber via a main duct hose. In a dust chamber, all received hazardous particles are contained and filtered. The dust chamber may include a water tank, a pump, a set of water nozzles to wash out the dust particles in the main duct and a replaceable filter. The dust chamber can be routinely cleaned or can be made of disposable material.

It is another object of this invention to disable the system in wet weather condition. This system also includes a shutter valve with a sensor in each air duct for closing the air duct. This feature is functional when the sensor senses water in the air duct.

It is another object of this invention to provide a method of collecting and filtering the hazardous particles. In this system, using vacuum source for capturing and collecting dust particles via air duct hoses from each wheel and combing all the duct hoses to the main hose, spraying all the dust particles in main hose and sending them to the dust chamber for the filtering process.

Further objects and advantages of this invention will become apparent from consideration of the drawings and descriptions that follow.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the present invention showing the collection dust chamber system in conjunction with a vehicle.

FIG. 2 is a side view of collection dust chamber system in conjunction with a vehicle.

FIG. 3 is an enlarged cutaway view of front wheel shown in FIG. 2.

FIG. 4 is an assembly cross section of dust chamber.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

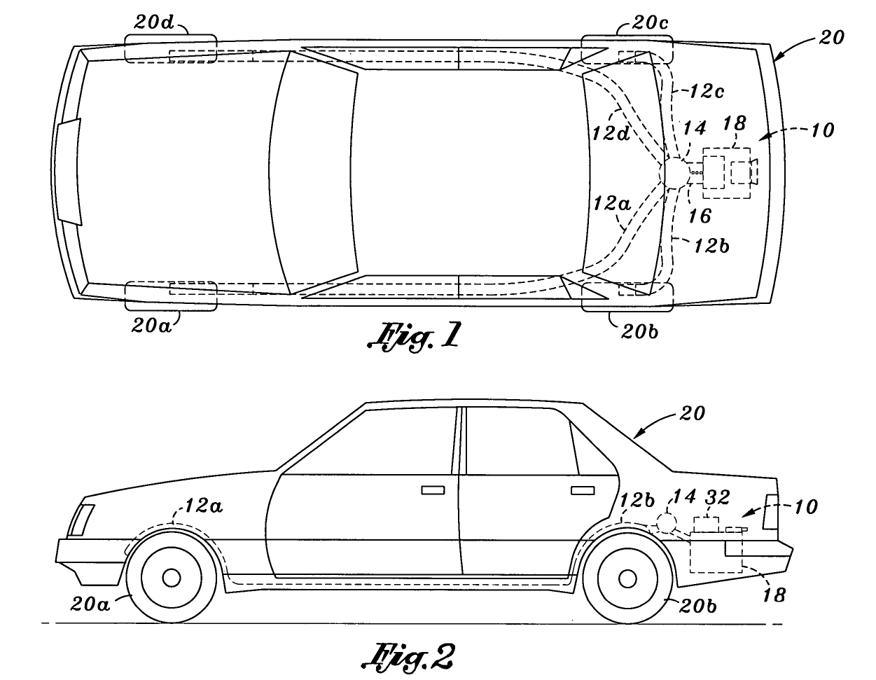

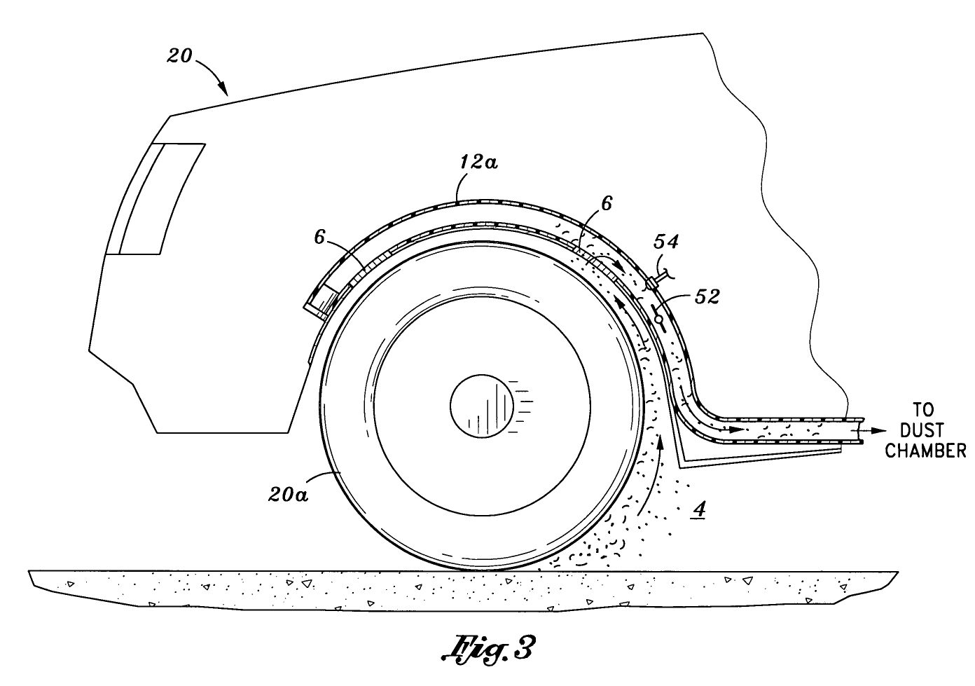

FIG. 1-2 is showing a collection dust chamber system 10 in conjunction with a vehicle 20. This system is capturing/collecting airborne hazardous particles generated by rotating vehicle's wheels. The hazardous particles consist of tire wear out particles, brake pads dust, asphalt dust, etc. This system has a vacuum source 14 to capture hazardous particles via directional air ducts 12a, 12b, 12c, 12d, which are located right above each tire 20a, 20b, 20c, 20d. All air ducts are connected to the dust chamber 18. Optionally all air ducts 12a-12d, can be connected to a main duct hose 16 and then can be connected to dust chamber 18.

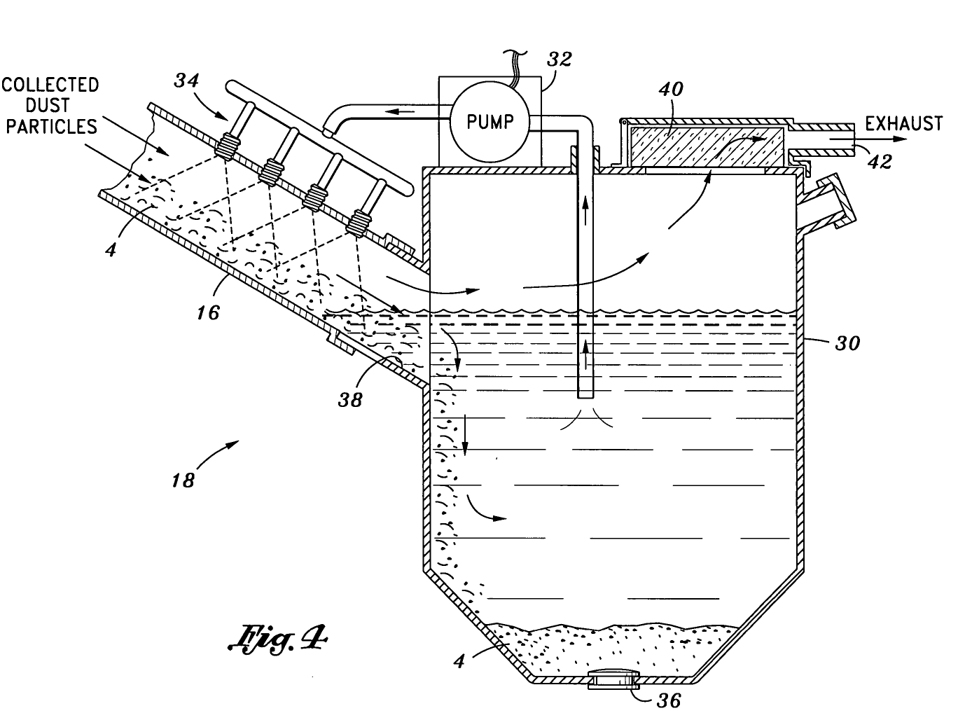

FIG. 3 is illustrating a frontal vehicle's wheel that shows an air duct hose 12a is located right above the tire 20a. This air duct hose has a couple of passage ports 6 at distal end and they are covered with screen meshes. As the suction is applied from vacuum source 14, the dust particles 4 are sucked into the air duct hose 12a. The screen meshes prevent larger particles to go into the air duct hose. It is another object of this invention to disable the system in wet weather condition. This system also includes a shutter valve 52 with a sensor 54 into each air duct for closing the air duct. This feature is functional when the sensor senses water in the air duct. Once all dust form particles are sucked into air duct hoses, the particles are send out to the dust chamber 18. As shown in FIG. 4, in dust chamber 18, all receiving particles 4 are contained and filtered. The dust chamber may include a water tank 30, a pump 32, a set of water nozzle 34 to wash out the dust particles 4 in the a main duct hose 16 and a replaceable filter 40. The dust chamber 18 can be routinely cleaned or can be made of disposable material.

It is another object of this invention to provide a method of collecting and filtering the hazardous particles. In this system, using a vacuum source for capturing and collecting dust particles via air duct hoses from each wheel and combing all the duct hoses into a main hose, spraying all the dust particles in main hose and sending them to the dust chamber for filtering process.

While this invention is susceptible of embodiments in many different forms, this specification and the accompanying drawings disclose only some specific forms as examples of the invention. The invention is not intended to be limited to the embodiments so described; however, the scope of the invention is pointed out in the appended claims.

We claim:

1. A collection dust chamber apparatus to be used in conjunction with a moving vehicle comprising:
a vacuum source,
at least one air duct hose, said air duct hose has at least one passage port at distal end to provide suction air flow passage for said vacuum source, said air duct hose is located right above vehicle's wheel to capture dust particles from said vehicle's wheel via said air duct hose passage port, and;
a dust chamber, said dust chamber is connected to said air duct hose at proximal end, said dust chamber receives said dust particles from said air duct hose for collecting and filtering purposes.

2. A collection dust chamber apparatus according to claim 1, wherein said air duct passage port have screen mesh to prevent large particle enters said air duct hose.

3. A collection dust chamber apparatus according to claim 1, wherein said air duct hose has a shutter valve next to said passage port.

4. A collection dust chamber apparatus according to claim 1, wherein said air duct hose has a shutter valve next to said passage port.

5. A collection dust chamber apparatus according to claim 1, wherein said dust chamber includes a water tank, a water pump, at least one water nozzle and a replaceable filter.

6. A collection dust chamber apparatus to be used in conjunction with a moving vehicle comprising:
a vacuum source,
at least one air duct hose, said air duct hose has at least one passage port at distal end to provide suction air flow passage for said vacuum source, said air duct hose is located right above vehicle's wheel to capture dust particles from said vehicle's wheel via said air duct hose passage port, and;
a main duct hose, said main duct connected at distal end to at least one said air duct hose at its proximal end, and;
a dust chamber, said dust chamber is connected to said main duct hose at proximal end, said dust chamber receives said dust particles from said air duct hose for collecting and filtering purposes.

7. A method for collection dust chamber apparatus to be used in conjunction with a moving vehicle comprising:
using a vacuum source for capturing and collecting dust particles via at least one air duct hose, said air duct hose has at least one passage port at distal end to provide suction air flow passage for said vacuum source, said air duct hose is located right above vehicle's wheel,
spraying all the dust particles in main duct hose, and;
sending all dust particles to dust chamber for filtering process.
